(19) United States
(12) Patent Application Publication
(10) Pub. No.: US 2025/0091073 A1
(43) Pub. Date: Mar. 20, 2025

(54) DISPENSER FOR A FLUID PRODUCT AND ASSOCIATED RECEPTACLE

(71) Applicant: ALBEA SERVICES, Gennevilliers (FR)

(72) Inventors: Thomas Emmanuel SOURDEAU, Gennevilliers (FR); Olivier CHAPLIER, Gennevilliers (FR); Guillaume MOURARET, Gennevilliers (FR)

(73) Assignee: ALBEA SERVICES, Gennevilliers (FR)

(21) Appl. No.: 18/887,717

(22) Filed: Sep. 17, 2024

(30) Foreign Application Priority Data
Sep. 20, 2023 (FR) 2309940

(51) Int. Cl. B05B 11/10

(52) U.S. Cl. CPC B05B 11/1077; B05B 11/1001; B05B 11/1074

(57) ABSTRACT

An actuating head configured to be mounted on a dispensing body of a fluid product comprising a pipette. The actuating head includes a piston and an actuator, a translation of which from an actuated end position to a rest position allows for suction into the pipette of the fluid product and a translation from the rest position to the actuated end position allows a distribution of the fluid product outside the pipette. A return means allowing a return of the piston and actuator to the rest position. The piston, the actuator and the return means are made from a single plastic part.

### CROSS-REFERENCE TO RELATED APPLICATIONS

This application claims priority to French Application No. 2309940, filed Sep. 20, 2023, the contents of which is incorporated herein by reference in its entirety.

### TECHNICAL FIELD OF THE INVENTION

The invention relates to a dispenser for a fluid product configured to be reversibly mounted on a reservoir with a fluid product.

The invention also relates to a receptacle comprising such a dispenser.

The fluid product is of the lotion, gel, perfume, serum or cream type, for example, used for cosmetic purposes or pharmaceutical treatments.

### TECHNICAL BACKGROUND

There are dispensing systems designed to equip receptacles and allow a fluid product to be picked up and dispensed. Typically, these dispensing systems comprise a piston that can move in translation from a rest position to a collecting or dispensing position. This translational movement is generally obtained by means of a push button (or actuator) linked in translation to the piston, on which pressure exerted by a user, in particular direct pressure, causes the piston to move and the collection and/or distribution of a dose of fluid product.

Such systems can be found, for example, in dropper-type receptacles in which the collection and the distribution of the product must be done precisely and in low dosage. These systems replace conventional systems comprising a flexible bulb that allows suction and/or dispensing of the product into a pipette housed in a reservoir containing the product. A first pressure allows suction of the product and a second pressure allows distribution of the product.

These systems also generally include a return means of the piston and push button, which allows the piston and push button to return automatically to the rest position once the dose of fluid product has been collected and/or distributed. In other words, the piston returns to the rest position without any action on the part of the user, and drives the push button, which also returns to the rest position.

Typically, the return means is a spring, in particular a helical spring. To ensure effective return of the piston and push button, particularly in terms of longevity, the spring is generally made of metal.

As a result, these systems are generally made up of a multitude of parts that do not facilitate assembly and result in a system that is not economical to manufacture.

It also increases the risk of the system malfunctioning. For example, with wear, play may develop between the various parts, or the return of the piston and/or push button may not be done completely. The stroke is then incomplete and the dose of fluid product is lower than expected, or the system may block or become difficult to use.

Moreover, the parts may be made of different materials, in particular those adapted to their functionality, complicating recycling.

There is therefore a need for a solution that solves at least some of the disadvantages of the prior art while maintaining a system that is advantageously simple and economical to manufacture.

### SUMMARY OF THE INVENTION

Thus, the invention relates to an actuating head configured to be mounted on a dispensing body of a fluid product comprising a pipette, the actuating head comprising a piston and an actuator, a translation of which from an actuated end position to a rest position allows for suction into the pipette of the fluid product and translation from the rest position to the actuated end position allows a distribution of the fluid product outside the pipette, and a return means allowing a return of the piston and the actuator to the rest position, the piston, the actuator and the return means being made from a single plastic part.

By actuator, we mean a push button on which pressure exerted by a user, in particular direct pressure, causes the piston to move and the collection and/or distribution of a dose of fluid product.

The return means allows the piston and actuator to return automatically, in other words spontaneously, i.e. the piston and actuator return to their rest position on their own after being lowered, without the need for the user to intervene.

The fact that the piston, actuator and return means are made in a single piece also allows for a smooth return movement. The piston and the actuator return to the rest position without any sudden movement, unlike a conventional helical spring. The return movement is easier to control.

This also prevents one of the parts from becoming defective or an offset in one of them, leading to a malfunction in the dispenser for which the distribution head is intended.

Finally, as the whole unit is made of plastic, recycling of the dispenser, and consequently recycling of the receptacle for which it is intended, is made easier.

According to various embodiments of the invention, which may be taken together or separately:
the piston, the actuator and the return means form a monolithic part,
the piston, the actuator and the return means are made of polypropylene,
the piston is mounted so as to slide in a sealed manner,
the return means comprises a wall of variable height, the height Hmax being maximum when the piston and actuator are in the rest position, and the height Hmin being minimum when the piston and actuator are in the actuated end position,
the wall of the return means is formed from a plurality of strips of material,
the strips of material delimit a cavity in which the piston is housed,
the return means envelopes the piston,
the strips of material extend longitudinally or helically from an upper end to an opposite lower end,
the return means comprises a lower positioning annulus,
each of the strips of material is attached to the positioning annulus at their lower end,
each of the strips of material is linked to the actuator,
the strips of material are transverse annulus,
the strips of material extend annularly,
the transverse annulus are stacked parallel to each other,
the transverse annulus are connected to each other by material bridges,
the material bridges are aligned,
the material bridges are offset,
the return means is connected to the actuator and/or the piston,
the return means is continuous with the material of the actuator,
the return means is continuous with the piston,
the return means and the actuator have substantially identical diameters,
the return means and the piston have substantially identical diameters,
the piston extends from an upper transverse wall of the actuator,
the actuator has a housing in which the piston is located,
the piston protrudes from an upper transverse wall of the actuator.

The invention also relates to a dispenser for a fluid product configured to be removably mounted on a reservoir of a fluid product, the dispenser comprising an actuating head as previously described and a dispensing body of the fluid product.

The dispensing body comprises a pipette configured to enable storage of fluid product for dispensing, a translation from an actuated end position to a rest position allows a suction of the fluid product into the pipette and a translation from the rest position to the actuated end position allows a distribution of the fluid product outside the pipette.

According to various embodiments of the invention, which may be taken together or separately:
the dispensing body comprises an upper housing, the return means being housed in the upper housing,
the dispensing body also comprises an external envelope linked to the dispensing body in rotation and translation,
the dispensing body comprises a closure ring configured to be reversibly attached to the reservoir,
a lower end of the return means rests on the closure ring,
the positioning annulus of the return means resting on the closure ring,
the external envelope covers the return means,
the external envelope covers the upper housing of the dispensing body,
the external envelope covers the closure ring of the dispensing body,
the dispensing body further comprises an external skirt configured to envelope the closure ring and the actuating head,
the pipette, closure ring and external skirt are made in a single piece,
the pipette, the closure ring and the external skirt forming the dispensing body form a monolithic part.
the dispensing body comprises a storage chamber, the piston being housed in the storage chamber when the actuating head and dispensing body are assembled,
the dispenser is made from a single material,
The dispenser is made of polypropylene.

The invention also relates to a receptacle comprising a reservoir of fluid product on which a dispenser as described above is reversibly mounted.

Advantageously, the receptacle is made of a single material, such as polypropylene.

### BRIEF DESCRIPTION OF THE FIGURES

The invention will be better understood, and other characteristics and advantages thereof will become apparent in the course of the detailed description which follows, of at least two examples of embodiments of the invention given by way of purely illustrative and non-limiting examples, with reference to the appended schematic drawings in which:

FIG. 1 is a longitudinal sectional view of a receptacle comprising a reservoir and a dispenser for a fluid product according to a first embodiment of the invention in a rest position;

FIG. 2 is a longitudinal sectional view of the dispenser in FIG. 1 in an actuated end position;

FIG. 3 is a longitudinal sectional view of a receptacle comprising a reservoir and a dispenser for a fluid product according to a second embodiment of the invention in a rest position;

FIG. 4 is a perspective view of a first variant of the return means shown in FIGS. 1 and 3;

FIG. 5 is a perspective view of a second variant of the return means shown in FIG. 4;

FIG. 6 is a perspective view of a third variant of the return means shown in FIG. 4;

FIG. 7 is a perspective view of a fourth variant of the return means shown in FIG. 4;

FIG. 8 is a perspective view of a fifth variant of the return means shown in FIG. 4.

### DETAILED DESCRIPTION OF THE INVENTION

By convention, the “axial” direction in the figures corresponds to that of the main axis X of a dispenser 10 for a fluid product configured to be removably mounted on a reservoir 12 of fluid product, and the “radial” direction is orthogonal to the axial direction.

In the following detailed description of the figures, the terms “upper” and “lower” or “top” and “bottom” will be used without limitation in reference to the axial direction.

Similarly, the terms “outer or external” and “inner or internal” are used with reference to the radial direction, an outer element being radially further from the axis X than an inner element.

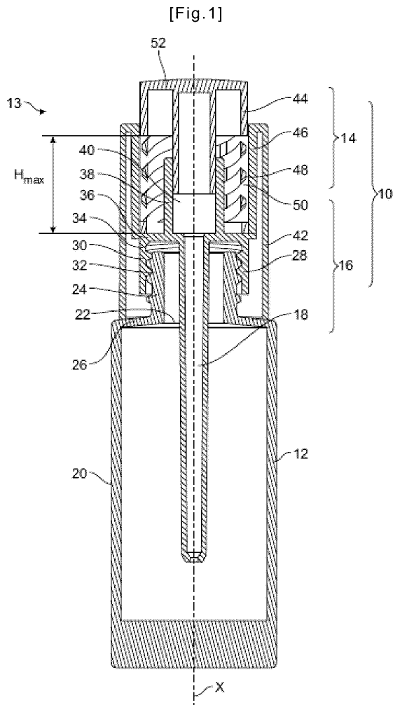

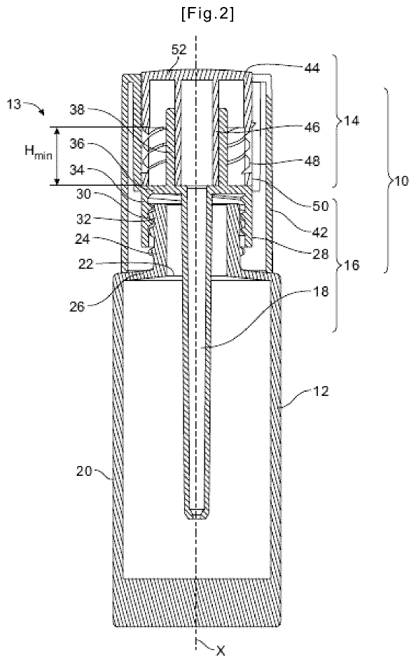

FIGS. 1 and 2 illustrate a first embodiment of a receptacle 13 comprising a dispenser 10 for a fluid product removably/reversibly mounted on a reservoir 12.

“Removable” or “reversible” means that the reservoir 12 can be fitted with the dispenser 10 and removed, in particular when dispensing the fluid product, without destroying or deforming either of the two elements.

The fluid product is of the lotion, gel, perfume, serum or cream type, for example, used for cosmetic purposes or pharmaceutical treatments.

The dispenser 10 comprises an actuating head 14 and a dispensing body 16. The removable connection between the dispenser 10 and the reservoir 12 is made via the dispensing body 16.

The dispensing body 16 comprises:
a pipette 18, and
a closure system that seals the reservoir 12 when the dispensing body 16 is mounted on the reservoir 12.

The pipette 18 is configured to enable the storage of fluid product for dispensing and to be housed inside the reservoir 12.

The reservoir 12 is configured to contain the fluid product and receive the pipette 18.

The closure system ensures the seal of the reservoir 12 when the pipette 18 is housed therein.

The reservoir 12 comprises a longitudinal wall 20 and a top opening 22. The longitudinal wall 20 delimits an internal volume in which the fluid product can be stored. The upper opening 22 is delimited by a neck 24 connected to the longitudinal wall 20 by a frustoconical shoulder 26.

The closure system consists of a closure ring 28 configured to be removably attached to the reservoir 12.

To do this, the closure ring 28 comprises closure means 30 cooperating with closure means 32 of the reservoir 12.

The closure means 30 of the closure ring 28 are located on an internal surface of a lower skirt 34.

The lower skirt 34 extends downwards from a transverse wall 36.

The closure means of the reservoir 12 are located on an external surface of the neck 24.

This is a threading system 30, 32. The closure ring 28 can thus be attached to and/or removed from the reservoir 12 by rotating it relative to the other.

The dispensing body 16 further comprises an upper skirt 38 defining an internal housing extended by the pipette 18.

The internal housing thus forms a storage chamber 40 in fluid connection with the pipette 18. More specifically, the lower part of the upper skirt 38 is connected to an upper end of the pipette 18 via the transverse wall 36. An opposite lower end of the pipette 18 is open and configured to be immersed in the reservoir 12 when the closure ring 28 is mounted on the reservoir 12.

The pipette 18 is used to store the dose of fluid product collected for dispensing.

In this first embodiment, the dispensing body 16 also comprises an external skirt 42.

The external skirt 42 envelopes the closure ring 28 and the actuating head. It therefore allows to conceal these unpleasant elements, in particular the elements making up the actuating head.

Advantageously, in the illustrated embodiments, the pipette 18, the closure ring 28 and the external skirt 42 forming the dispensing body 16 are made in a single piece. In other words, they form a monolithic piece. Design and assembly are thus made easier. There is also no risk of play between the parts as use progresses.

Preferably, the assembly is made of plastic, making it easier to recycle the dispenser and, consequently, the receptacle for which it is intended.

The second embodiment differs from the first in that it has an external envelope 43.

Advantageously, the external envelope 43 is linked in rotation and translation to the dispensing body 16.

In particular, in this second embodiment, the external envelope 43 is linked in rotation with the dispensing body 16 via the external skirt 42 by cooperation of vertical grooves located at their lower end and their upper end.

In addition, the external envelope 43 and the external skirt 42 of the dispensing body 16 are connected in translation by latching together at their lower end and upper end.

The external envelope 43 can be used, for example, to provide an additional design and improve the aesthetics of the receptacle 13.

In the embodiments shown here, the actuating head 14 comprises an actuator 44, a piston 46 and a return means 48 allowing a return of the piston 46 and actuator 44 to the rest position.

By actuator, we mean a push button on which pressure exerted by a user, in particular direct pressure, causes the piston to move and the collection and/or distribution of a dose of fluid product.

According to the invention, the piston 46, the actuator 44 and the return means 48 are made from a single plastic part. In other words, the piston 46, actuator 44 and return means 48 form a monolithic part.

In other words, unlike conventional systems comprising an independent helical spring, the compression, the crushing of the return means 48 directly causes the piston 46 to descend without any intermediate part. The piston 46 is actuated by the actuator 44 and the return means 48.

This configuration allows the actuator 44, return means 48 and piston 46 to be held securely in place. This facilitates the return of the actuator 44 and the piston 46 to their rest position and allows a uniform and durable movement over the long term.

Preferably, the piston 46, actuator 44 and return means 48 are made of polypropylene, for example post-consumer recycled polypropylene.

The polypropylene is a plastic with a well-known recycling cycle.

Advantageously, the actuating head 14 is mounted on the dispensing body 16 so that the actuator 44 can move in axial translation relative to the external skirt 42 of the dispensing body 16 and the external envelope 43.

In the embodiments illustrated here, the dispensing body 16 comprises an upper housing 50 in which the return means 48 is housed. The upper housing 50 and the return means 48 are covered by the external skirt 42 of the dispensing body 16.

In the second embodiment, the external envelope 43 also covers the upper housing 50 and the return means 48.

In the embodiments illustrated here, the piston 46 extends from an upper transverse wall 52 of the actuator 44 towards the interior of the receptacle 13.

In other words, the piston 46 protrudes from the upper transverse wall of the actuator 44.

In particular, the actuator 44 has a housing in which the piston 46 is located. When the actuating head 14 is mounted on the dispensing body 16, the piston 46 is housed in the storage chamber 40 of the dispensing body 16 and has an external diameter substantially similar to the internal diameter of the storage chamber 40 so that translation thereof may involve the suction or the distribution of the cosmetic product into the pipette 18.

Indeed, as the actuator 44 is linked in translation with the piston 46, a pressure on the actuator 44 causes the piston 46 in the storage chamber 40 to descend from its rest position to its end position of collecting or dispensing.

Similarly, a rise in the actuator 44 causes the piston 46 to rise.

The dose of fluid product is thus collected and/or distributed by a vertical translation movement of the actuator 44 which causes a translation (or sliding) movement of the piston 46 in the storage chamber 40.

Preferably, the piston slides in a sealed manner to facilitate the collection and distribution of the fluid product.

When the pipette 18 is empty, a rise in the piston 46 causes the collect of the fluid product and fill the pipette 18 in the reservoir 12 of fluid product.

When the pipette 18 comprises the fluid product, lowering the piston 46 causes the distribution of the fluid product contained in the pipette 18.

Advantageously, the return means 48 allows the return of the piston 46 and the actuator 44 to the rest position.

The return is automatic, in other words spontaneous, i.e. the piston 46 and the actuator 44 return to their rest position on their own after being lowered, without the need for the user to intervene.

So when the user releases the actuator 44, the assembly returns automatically and spontaneously to the rest position, i.e. without the need for the user to intervene.

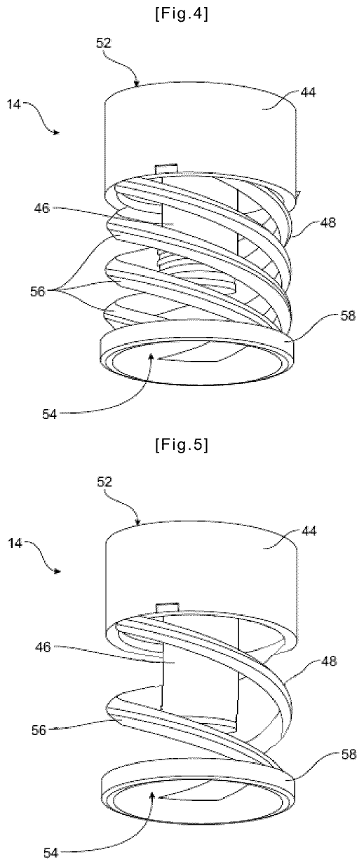

FIGS. 4 to 8 illustrate several examples of an actuating head 14 which differ in the nature of the return means 48.

In each of these examples of realisation, the return means 48 forms a cavity 54 delimited by a wall and in which the piston 46 is housed.

Advantageously, the wall of the return means 48 is flexible.

In this way, the flexibility of the wall allows variability in the height of the cavity 54 during the translational movement of the actuator 44.

The cavity 54 thus has a variable height Hmax, Hmin. The height Hmax is maximum when the piston 46 and the actuator 44 are in the rest position, and the height Hmin is minimum when the piston 46 and the actuator 44 are in the actuated end position,

So, when the piston 46 and the actuator 44 are in the rest position, the height is maximum Hmax.

As the piston 46 and actuator 44 are lowered, the height of the cavity 54 decreases to a minimum height Hmin. The piston 46 and the actuator 44 are then in an end position of collecting or dispensing.

In other words, the return means 48 has an extended position illustrated in FIG. 1 corresponding to a rest position and a retracted position illustrated in FIG. 2 corresponding to an end position of collecting or dispensing.

Advantageously, the flexible wall is a lateral flexible wall. In other words, the cavity 54 is delimited by a lateral flexible wall.

In the examples shown, the return means 48, in this case the flexible wall, is connected to the actuator 44 and is continuous with it. The return means 48 and the actuator 44 then have substantially identical diameters.

In other embodiments not shown, the return means 48 is connected to the piston 46 and is continuous with it. The return means 48 then has a diameter substantially identical to that of the piston 46.

“Continuous” here means that the return means 48 is directly connected to the actuator 44 and/or the piston 46, in particular without any intermediate part and/or element.

The flexible wall can be a solid wall or a perforated wall.

Advantageously, the wall of the return means 48 is formed by a plurality of strips 56 of material. The strips 56 of material delimit the cavity 54 in which the piston 46 is housed.

Advantageously, the return means 48 comprises a lower positioning annulus 58. The positioning annulus 58 allows to hold the return means 48 in position in the dispensing body 16.

In particular, when the wall of the return means 48 is formed of strips 56 of material, each of the strips 56 of material is connected to the positioning annulus 58 at their lower end, ensuring that they are held in position, in particular with good spacing between them.

Preferably, the positioning annulus 58 rests on the closure ring 28, for example on the transverse wall 36 thereof, and the return means 48 envelopes the upper skirt 38 of the closure ring 28, as shown in the illustrated embodiments. In other words, the upper skirt 38 of the closure ring 28 is located in the cavity 54 of the return means 48.

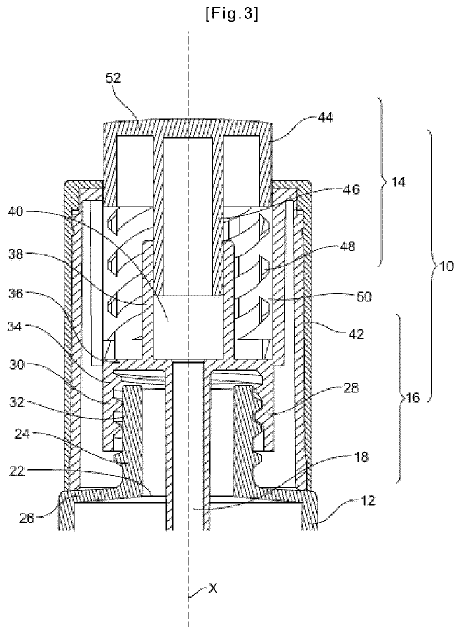

In the first, second and third embodiments of the return means 48 shown in FIGS. 1 to 4, 5 and 6 respectively, the wall of the return means 48 is formed by a plurality of strips 56 of material extending helically from an upper end projecting from the actuator 44 towards an opposite lower end and connected to the positioning annulus 58.

In the first example of the return means 48 shown in FIGS. 1 to 4, the wall of the return means 48 is formed by four strips 56 of material extending helically and winding in the same direction of rotation around the piston 46.

The helical winding ensures the flexibility of the wall of the return means 48 and its variability in height.

In the second example of the return means 48 illustrated in FIG. 5, the wall of the return means 48 is formed by two strips 56 of material extending helically and winding in the same direction of rotation around the piston 46.

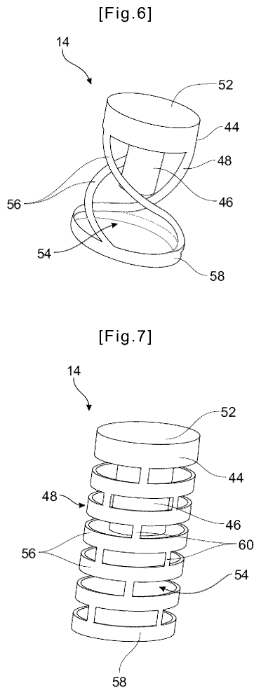

In the third example of the return means 48 illustrated in FIG. 6, the wall of the return means 48 is formed by four strips 56 of material extending helically and winding in two opposite directions of rotation around the piston 46. In other words, two strips 56 of material are wound in a clockwise direction and two strips 56 are wound in an anticlockwise direction so that they cross at certain points.

In the fourth example of the return means 48 illustrated in FIG. 7, the wall of the return means 48 is formed by strips 56 of material which are transverse annulus in the extension of the actuator 44. In other words, the strips 56 of material extend annularly around the piston 46.

The wall of the return means 48 is thus formed by transverse annulus stacked parallel to each other and connected by material bridges 60.

The material bridges 60 ensure the flexibility of the wall of the return means 48 and its variability in height.

In this example, the material bridges 60 are offset.

In other embodiments not shown, the material bridges are aligned.

The upper annulus is linked to the actuator 44 by the material bridges 60. The lower annulus corresponds to the positioning annulus 58.

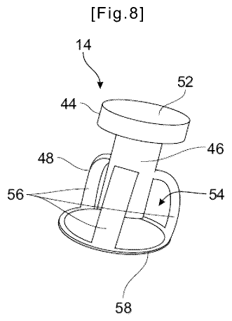

In the fifth example of the return means 48 shown in FIG. 8, the flexible wall is formed by three strips 56 of material projecting from the outer surface of the piston 46 and evenly spaced around the piston 46. The strips 56 extend longitudinally from an upper end 60 located on the outer wall of the piston 46 to an opposite lower end 62 where they are connected to the positioning annulus 58. The strips 56 are evenly distributed over the positioning annulus 58.

Each of the strips 56 thus extends downwards so that the cavity 54 has a concave shape towards the lower part of the dispenser 10.

The flexibility of each of the strips 56 allows the variability of the height Hmax, Hmin of the cavity 54 of the return means 48 and the return of the piston 46 and the actuator 44 to the rest position.

Advantageously, the dispenser 10 is made from a single material. Preferably, the dispenser 10 is made entirely of plastic.

In other words, the actuating head 14 and the dispensing body 16 are made of the same material, or at least similar materials.

By similar materials we mean materials that will have at least one common recycling circuit.

The use of the same material, or at least similar materials, to make the various parts of the refill 16 is particularly advantageous for their recycling after use of the fluid product. Indeed, the presence of different materials presents disadvantages when it comes to recycling, where the parts have to be separated. The use of the same material allows all the parts of the refill 16 to be throw away together without having to dismantle it, which facilitates recycling.

The material may be selected from polypropylene (PP), polyethylene terephthalate (PET), recycled polyethylene terephthalate (R-PET), thermoplastic elastomer (TPE), polyethylene (PE), such as low-density polyethylene (LDPE) and/or high-density polyethylene (HDPE), composite material, post-consumer recycled (PCR) material and/or a similar material.

Preferably, the material is selected from polypropylene, polyterephthalate, post-consumer recycled polypropylene, post-consumer recycled polyterephthalate, or a mixture thereof.

Polypropylene and polyethylene terephthalate are two plastics with well-known recycling cycles.

Typically, the reservoir 12 is made of glass. It can also be made of plastic, wood, metal, hybrid material or mixtures of these.

The disassembly of the actuating head 14 and the dispensing body 16 and the disassembly of the dispensing body 16 and the reservoir 12 being easy, and the fact that the reservoir 12 is made of a different material does not complicate recycling, each of the parts being recycled in its own recycling cycle.

Advantageously, the receptacle 13 is made from a single material, preferably a plastic such as polypropylene.

1. An actuating head configured to be mounted on a dispensing body of a fluid product comprising a pipette,
the actuating head comprising a piston and an actuator, a translation of which from an actuated end position to a rest position allows for suction into the pipette of the fluid product and translation from the rest position to the actuated end position allows a distribution of the fluid product outside the pipette, and a return means allowing a return of the piston and the actuator to the rest position,
the piston, the actuator and the return means being made from a single plastic part.

2. The actuating head according to claim 1, wherein the piston, the actuator and the return means are made of polypropylene.

3. The actuating head according to claim 1, wherein the return means comprise a wall of variable height, the height Hmax being maximum when the piston and the actuator are in the rest position, and the height Hmin being minimum when the piston and the actuator are in the actuated end position.

4. The actuating head according to claim 3, wherein the wall of the return means is formed from a plurality of strips of material.

5. The actuating head according to claim 4, wherein the strips of material delimit a cavity in which the piston is housed.

6. The actuating head according to claim 4, wherein the strips of material extend longitudinally or helically from an upper end to an opposite lower end.

7. The actuating head according to claim 4, wherein the strips of material are transverse annulus.

8. The actuating head according to claim 1, the return means is connected to the actuator and/or to the piston.

9. The actuating head according to claim 1, wherein the piston extends from an upper transverse wall of the actuator.

10. A dispenser for a fluid product configured so as to be removably mounted on a reservoir of a fluid product, the dispenser comprising an actuating head according to claim 1 and a dispensing body of the fluid product, the dispensing body comprising a pipette configured to enable storage of fluid product for dispensing, a translation of the piston and of the actuator from an actuated end position to a rest position allows a suction into the pipette of the fluid product and translation from the rest position to the actuated end position allows a distribution of the fluid product outside the pipette.

11. The dispenser according to claim 10, wherein the dispensing body comprises an upper housing, the return means being housed in the upper housing.

12. The dispenser according to claim 11, wherein the dispensing body further comprises a closure ring configured to be reversibly attached to the reservoir, and an external skirt configured to envelope the closure ring and the actuating head, the pipette, the closure ring and the external skirt being made in a single piece.

13. The dispenser according to claim 10, wherein the dispensing body comprises a storage chamber, the piston being housed in the storage chamber when the actuating head and the dispensing body are assembled.

14. The dispenser according to claim 10, made of a single material, such as polypropylene.

15. A receptacle comprising a reservoir with a fluid product on which a dispenser according to claim 10 is reversibly mounted.

16. The receptacle according to claim 15, made from a single material, such as polypropylene.
